(19) United States
(12) Patent Application Publication
(10) Pub. No.: US 2025/0051497 A1
(43) Pub. Date: Feb. 13, 2025

(54) PROCESS FOR PREPARING ETHYLENE POLYMERS IN A SLURRY POLYMERIZATION

(71) Applicant: Basell Polyolefine GMBH, Wesseling (DE)

(72) Inventors: Elke Damm, Bad Vilbel (DE); Harald Prang, Erftstadt (DE); Reinhard Kuehl, Bornheim (DE)

(73) Assignee: Basell Polyolefine GMBH, Wesseling (DE)

(21) Appl. No.: 18/720,775

(22) PCT Filed: Dec. 20, 2022
(86) PCT No.: PCT/EP2022/086851

§ 371 Date: Jun. 17, 2024

(30) Foreign Application Priority Data
Dec. 22, 2021 (EP) 21216856.1

(51) Int. Cl. C08F 210/16; C08F 2/00; C08F 2/06

(52) U.S. Cl. CPC C08F 210/16; C08F 2/002; C08F 2/008; C08F 2/06; C08F 2500/05

(57) ABSTRACT

A process for polymerizing or copolymerizing ethylene in a slurry polymerization in a reactor system including a polymerization reactor, one or more first heat exchangers located outside the polymerization reactor, and a closed loop of a tempering medium for cooling or heating the first heat exchangers, which closed loop is equipped with second heat exchangers for cooling the tempering medium and third heat exchangers for heating the tempering medium, and wherein, during the polymerization, the slurry is cooled in the first heat exchangers, the temperature of the tempering medium cooling the first heat exchangers is in the range from 20° C. to 50° C., and the tempering medium is cooled in the second heat exchangers by a coolant, having a temperature from −20° to 45°° C.

### FIELD OF THE INVENTION

In general, the present disclosure relates to the field of chemistry. More specifically, the present disclosure relates to polymer chemistry. In particular, the present disclosure relates to a process for polymerizing ethylene or copolymerizing ethylene and one or more C₃-C₁₂-1 alkenes in a slurry polymerization.

### BACKGROUND OF THE INVENTION

In some instances, slurry polymerization processes are used for preparing ethylene polymers. In some instances, such processes are carried out in a series of reactors, thereby allowing different reaction conditions in the polymerization reactors and producing different polymer compositions in the individual polymerization reactors. In some instances, slurry processes for preparing ethylene polymers employ a hydrocarbon or a hydrocarbon mixture as diluent. In some instances, the slurry is a suspension of ethylene polymer particles in a liquid medium which is made from or containing the hydrocarbon diluent and other components like dissolved ethylene, comonomers, aluminum alkyls, hydrogen, and dissolved reaction products like oligomers and waxes.

In some instances, slurry polymerization systems for preparing ethylene polymers use external heat exchangers in a reactor recirculation loop, thereby removing heat produced in the ethylene polymerization reactions. In some instances and caused by a reduced solubility at lower temperature, low molecular weight waxes solidify when the slurry flows through the cooler and contacts the cold walls of the heat exchangers. In some instances, the solidified, low-molecular-weight waxes foul the heat exchangers and decrease the heat transfer in the heat exchanger, thereby reducing the efficiency of heat removal. In some instances, the solidified, low-molecular-weight waxes adhere to the walls of the polymerization reactors.

In some instances, cleaning methods include (a) flushing the polymerization system with a hydrocarbon at ambient temperature, (b) mechanical cleaning, for example, by hydro-jet devices, or (c) cleaning the reactor system with hot hydrocarbons. In some instances, the various cleaning methods result in rust formation or involve increased effort.

### SUMMARY OF THE INVENTION

In a general embodiment, the present disclosure provides a process for polymerizing ethylene or copolymerizing ethylene and one or more C₃C₁₂-1-alkenes in a slurry polymerization at temperatures of from 40 to 150° C. and pressures from 0.1 to 5 MPa in the presence of a polymerization catalyst,

wherein the process is carried out in a reactor system including
a polymerization reactor configured to have a content in liquid form;
an agitator for agitating the reactor content;
one or more first heat exchangers located outside the polymerization reactor for cooling or heating the reactor content;
one or more circulation pumps for withdrawing the reactor content from the polymerization reactor and circulating the reactor content through the one or more first heat exchangers; and
a closed loop of a tempering medium for cooling or heating the one or more first heat exchangers, wherein the closed loop is equipped with a second heat exchangers for cooling the tempering medium and a third heat exchangers for heating the tempering medium, and
   the process includes the steps of:
filling the polymerization reactor with a slurry of ethylene polymer particles in a liquid medium made from or containing a hydrocarbon diluent;
withdrawing the slurry from the polymerization reactor,
cooling the slurry in the one or more first heat exchangers,
returning the cooled slurry to the polymerization reactor,
cooling the one or more first heat exchangers with the tempering medium having a temperature in the range of from 20° C. to 50° C., and
cooling the tempering medium in the second heat exchangers by a coolant having a temperature from −20° to 45° C.

In some embodiments, the reactor system is a part of a series of two, three, or more reactor systems including each a polymerization reactor and one or more first heat exchangers located outside the polymerization reactor for cooling or heating the reactor content.

In some embodiments, the first heat exchangers are double pipe heat exchangers. In some embodiments, the double pipe heat exchangers have a surface roughness Ra of less than 5 μm, determined according to ASME B46.1.

In some embodiments, the polymerization reactors are further equipped at the reactor outside with tempering jackets.

In some embodiments, tempering jackets consist of a series of half-pipes attached to the outside of the polymerization reactors.

In some embodiments, the tempering medium for cooling or heating the tempering jacket is the tempering medium for cooling or heating the one or more first heat exchangers.

In some embodiments, the process further includes a cleaning step for cleaning (a) the polymerization reactor, (b) the one or more first heat exchangers, or (c) the polymerization reactor and the one or more first heat exchangers, including the sub-steps of:
terminating the polymerization of ethylene or the copolymerization of ethylene and one or more C₃-C₁₂-1-alkenes in the reactor system and discharging the slurry of ethylene polymer particles from the reactor system until the reactor system is empty,
introducing a hydrocarbon solvent into the emptied reactor system, thereby forming a cleaning fill within the reactor system,
heating the cleaning fill within the reactor system to a temperatures from 100 to 180° C., including the further sub-steps of:
   (i) operating the agitator within the polymerization reactor;
   (ii) heating the cleaning fill by withdrawing parts of the cleaning fill from the polymerization reactor, heating the parts of the cleaning fill in the one or more first heat exchangers, and returning the heated parts of the cleaning fill to the polymerization reactor; and
   (iii) heating the tempering medium in the third heat exchanger by providing the third heat exchanger with a heating medium having a temperature from 150° C. to 250° C.;
maintaining the cleaning fill within the reactor system at the temperature from 100° C. to 180° C. for from 4 to 120 hours with continued circulation of the cleaning fill through the one or more first heat exchangers and continued operation of the agitator;
discharging the cleaning fill from the reactor system until the reactor system is empty; and
resuming polymerizing ethylene or copolymerizing ethylene and one or more C₃-C₁₂-1 alkenes in the reactor system.

In some embodiments, after discharging the slurry of ethylene polymer particles from the reactor system and before introducing the cleaning fill into the reactor system, the process further includes a sub-step of flushing the reactor system with hydrocarbon diluent.

In some embodiments, the sub-step of introducing the hydrocarbon solvent into the emptied reactor system involves introducing the hydrocarbon solvent until a liquid level of the cleaning fill within the polymerization reactor is at least as high as the liquid level of the slurry within the polymerization reactor during polymerization.

In some embodiments, the introduction of the hydrocarbon solvent into the reactor system is terminated after a cleaning fill within the reactor system has been formed. In some embodiments, the cleaning fill within the reactor system is thereafter maintained at the temperature from 100° C. to 180° C. In some embodiments, the discharge of the cleaning fill from the reactor system occurs without introducing additional hydrocarbon solvent.

In some embodiments, during the maintenance of the cleaning fill within the reactor system at a temperature from 100° C. to 180° C., hydrocarbon solvent is continuously introduced into the reactor system and cleaning fill is continuously discharged from the reactor system.

In some embodiments, for emptying the reactor system before resuming the polymerization, the circulation of the cleaning fill from the polymerization reactor through the one or more first heat exchangers is terminated and the contents of the one or more first heat exchangers and the polymerization reactor are subsequently discharged.

In some embodiments, the cleaning fill, discharged from the reactor system, is transferred into an agitated evaporation vessel, which is configured to allow withdrawal of hydrocarbon solvent by evaporation from a liquid medium made from or containing the hydrocarbon solvent.

In some embodiments, the discharge of the cleaning fill from the reactor system into the agitated distillation vessel occurs by a pressure difference between the cleaning fill within the reactor system and the agitated distillation vessel.

In some embodiments, the resulting ethylene polymers are bimodal or multimodal ethylene polymers.

### BRIEF DESCRIPTION OF THE DRAWINGS

FIG. 1 shows a schematic of a slurry polymerization process for preparing multimodal ethylene polymers in a series of three polymerization reactors.

FIG. 2 shows a schematic of a reactor system of a slurry process for polymerizing ethylene or copolymerizing ethylene and one or more C₃-C₁₂-1-alkenes.

### DETAILED DESCRIPTION OF THE INVENTION

In some embodiments, the process is for polymerizing ethylene or copolymerizing ethylene and one or more C₃-C₁₂-1-alkenes in a slurry polymerization at temperatures from 40 to 150° C. and pressures of from 0.1 to 20 MPa in the presence of a polymerization catalyst. In some embodiments, the C₃-C₁₂-1-alkenes are linear or branched, alternatively linear C₃-C₁₀-1-alkenes or branched C₂-C₁₀-1-alkenes. In some embodiments, the linear C₃-C₁₀-1-alkenes are selected from the group consisting of propylene, 1-butene, 1-pentene, 1-hexene, 1-heptene, 1-octene, and 1-decene. In some embodiments, the branched C₂-C₁₀-1-alkenes are 4-methyl-1-pentene. In some embodiments, the ethylene is polymerized with mixtures of two or more C₃-C₁₂-1-alkenes. In some embodiments, comonomers are C₃-C₈-1-alkenes. In some embodiment, the C₃-C₈-1-alkenes are selected from the group consisting of 1-butene, 1-pentene, 1-hexene, 1-heptene, and 1-octene. In some ethylene copolymers, the amount of units derived from incorporated comonomers is from 0.01 wt. % to 25 wt. %, alternatively from 0.05 wt. % to 15 wt. %, alternatively from 0.1 wt. % to 12 wt. %. In some embodiments, ethylene is copolymerized with from 0.1 wt. % to 12 wt. % of 1-hexene or 1-butene, alternatively from 0.1 wt. % to 12 wt. % of 1-butene.

In some embodiments, the polymerization is carried out using olefin polymerization catalysts. In some embodiments, the polymerization is carried out using Phillips catalysts based on chromium oxide, titanium-based Ziegler-or Ziegler-Natta-catalysts, single-site catalysts, or mixtures of such catalysts. As used herein, the term “single-site catalysts” refers to catalysts based on chemically uniform transition metal coordination compounds. In some embodiments, mixtures of two or more of these catalysts are used for the polymerization of olefins. As used herein, mixed catalysts may be alternatively designated “hybrid catalysts.”

In some embodiments, the catalysts are of the Ziegler type. In some embodiments, the Ziegler-type catalysts are made from or containing a compound of titanium or vanadium, a compound of magnesium, and optionally an electron donor compound or a particulate inorganic oxide as a support material.

In some embodiments, catalysts of the Ziegler type are polymerized in the presence of a cocatalyst. In some embodiments, the cocatalysts are organometallic compounds of metals of Groups 1, 2, 12, 13, or 14 of the Periodic Table of Elements, alternatively organometallic compounds of metals of Group 13, alternatively organoaluminum compounds. In some embodiments, the cocatalysts are selected from the group consisting of organometallic alkyls. organometallic alkoxides, and organometallic halides.

In some embodiments, the organometallic compounds are selected from the group consisting of lithium alkyls, magnesium alkyls, zinc alkyls, magnesium alkyl halides, aluminum alkyls, silicon alkyls, silicon alkoxides, and silicon alkyl halides. In some embodiments, the organometallic compounds are selected from the group consisting of aluminum alkyls and magnesium alkyls. In some embodiments, the organometallic compounds are aluminum alkyls. alternatively trialkylaluminum compounds or compounds of this type wherein an alkyl group is replaced by a halogen atom. In some embodiments, the halogen is chlorine or bromine. In some embodiments, the aluminum alkyls are selected from the group consisting of trimethylaluminum, triethylaluminum, tri-isobutylaluminum, tri-n-hexylaluminum, diethylaluminum chloride, and mixtures thereof.

In some embodiments, the polymerization process is carried out as a slurry polymerization. As used herein, the term “slurry polymerizations” may alternatively be designated as “suspension polymerizations.” In some embodiments, the slurry polymerizations take place in a liquid medium made from or containing a hydrocarbon diluent, in which the produced ethylene polymer is insoluble and forms solid particles. In some embodiments, the otherwise liquid medium of the slurry is in a supercritical state under the conditions within the polymerization reactor. In some embodiments, the solids content of the slurry is in the range of from 10 to 80 wt. %. alternatively in the range of from 20 to 40 wt. %.

In some embodiments, the liquid medium is made from or containing the hydrocarbon diluent and components selected from the group consisting of, dissolved monomers or comonomers, dissolved cocatalysts or scavengers, dissolved reaction auxiliaries, and dissolved reaction products of the polymerization reaction. In some embodiments, the dissolved cocatalysts or scavengers are aluminum alkyls. In some embodiments, the dissolved reaction auxiliaries are hydrogen. In some embodiments, the dissolved reaction products of the polymerization reaction are oligomers or waxes. In some embodiments, the hydrocarbon diluents are inert, that is, do not decompose under reaction conditions. In some embodiments, the hydrocarbon diluents are hydrocarbons having from 3 to 12 carbon atoms. In some embodiments, the hydrocarbon diluents are saturated hydrocarbons. In some embodiments, the saturated hydrocarbons are selected from the group consisting of isobutane, butane, propane, isopentane, pentane, hexane, octane, and mixtures thereof. In some embodiments, the hydrocarbon diluent is a hydrocarbon mixture. In some embodiments, hydrocarbon mixtures have a boiling point range.

In some embodiments, the hydrocarbon diluent has a boiling point different from the boiling points of the monomers and comonomers, thereby permitting recovery of the starting materials from a mixture by distillation. In some embodiments, the hydrocarbon diluents are hydrocarbons having a boiling point above 40° C., alternatively above 60° C., or mixtures made from or containing hydrocarbons having the specified boiling point. In some embodiments, the polymerization takes place in a liquid medium made from or containing more than 50 wt. % of saturated hydrocarbons having a boiling point of above 60° C. at 0.1 MPa alternatively more than 80 wt. % of saturated hydrocarbons having a boiling point of above 60° C. at 0.1 MPa.

In some embodiments, the process is carried out at temperatures in the range from 40to 150° C., alternatively from 50 to 130° C., alternatively from 60 to 90° C., and at pressures from 0.1to 5 MPa, alternatively from 0.15 to 3 MPa, alternatively from 0.2 to 2 MPa. As used herein, pressures are understood as being absolute pressures, that is, pressure having the dimension MPa (abs).

In some embodiments, the polymerization is carried out in a series of at least two polymerization reactors which are connected in series. There is no limit to the number of reactors of such a series. In some embodiments, the series consist of two, three or four reactors, alternatively of two or three reactors. In some embodiments, a series of polymerization reactors is used, and the polymerization conditions in the polymerization reactors differ. In some embodiments, the polymerization conditions differ by the nature of comonomers, the amount of comonomers, or the different concentrations of polymerization auxiliaries. In some embodiments, the polymerization auxiliary is hydrogen.

In some embodiments, the ethylene polymers are obtained as powder. As used herein, the term “powder” refers to in the form of small particles. In some embodiments, the particles have a regular morphology and size, which depend on the catalyst morphology, the catalyst size, and polymerization conditions. In some embodiments and depending on the catalyst used, the particles of the polyolefin powder have a mean diameter of from a few hundred to a few thousand micrometers. In some embodiments and with chromium catalysts, the mean particle diameter is from about 300 to about 1600 μm. In some embodiments and with Ziegler type catalysts, the mean particle diameter is from about 50 to about 3000 μm. In some embodiments, the polyolefin powders have a mean particle diameter of from 100 to 250 μm. In some embodiments, the particle size distribution is determined by sieving, alternatively be vibrating sieve analysis, alternatively by sieve analysis under an air jet.

In some embodiments, the density of ethylene polymers obtained by the process is from 0.90 g/cm³ to 0.97 g/cm³, alternatively from 0.920 to 0.968 g/cm³, alternatively from 0.945 to 0.965 g/cm³. As used herein, the term “density” refers to the density determined according to DIN EN ISO 1183-1:2004, Method A (Immersion) with compression-molded plaques of 2 mm thickness which were pressed at 180° C., 20MPa for 8 minutes with subsequent crystallization in boiling water for 30 minutes.

In some embodiments, the ethylene polymers have a MFR21.6 at a temperature of 190° C. under a load of 21.6 kg, determined according to DIN EN ISO 1133:2005, condition G, from 0.5 to 300 g/10 min, alternatively from 1 to 100 g/10 min, alternatively from 1.2 to 100 g/10 min, alternatively from 1.5 to 50 g/10 min.

In some embodiments, the ethylene polymers are monomodal, bimodal, or multimodal ethylene polymers. In some embodiments, the ethylene polymers are bimodal or multimodal ethylene polymers. As used herein, the term “multimodal” refers to the modality of the resulting ethylene copolymer and indicates that the ethylene copolymer is made from or containing at least two fractions of polymer which are obtained under different reaction conditions, independently whether this modality is recognized as separated maxima in a gel permeation chromatography (GPC) curve. In some embodiments, the different polymerization conditions are achieved by using different hydrogen or different comonomer concentrations in different polymerization reactors. In some embodiments, the polymers are obtained from polymerizing olefins in a series of two or more polymerization reactors under different reaction conditions. In some embodiments, the bimodal or multimodal polyolefins are obtained by employing mixed catalysts. In some embodiments and in addition to the molecular weight distribution, the polyolefin has a comonomer distribution. In some embodiments, the average comonomer content of polymer chains with a higher molecular weight is higher than the average comonomer content of polymer chains with a lower molecular weight. As used herein, the term “multimodal” also includes “bimodal”.

In some embodiments, the polymerization is carried out in a series of polymerization reactors. In some embodiments, an ethylene homopolymer is prepared in the first polymerization reactor and an ethylene copolymer is prepared in a subsequent polymerization reactor. In some embodiments, the ethylene homopolymer is a low molecular weight ethylene homopolymer. In some embodiments, the ethylene copolymer is a high molecular weight ethylene copolymer. In some embodiments and to prepare an ethylene homopolymer in the first polymerization reactor, no comonomer is fed to the first polymerization reactor, neither directly nor as component of a feed stream or a recycle stream which is introduced into the first polymerization reactor of the series of polymerization reactors. In some embodiments, the resulting multimodal ethylene copolymers are made from or containing from 35 to 65% by weight of ethylene homopolymer prepared in the first polymerization reactor and from 35 to 65% by weight of ethylene copolymer prepared in the subsequent polymerization reactor. In some embodiments, the series of polymerization reactors includes one are more prepolymerization reactors, and the prepolymerization is carried out without adding comonomers.

In some embodiments, the ethylene polymer is prepared in a series of three polymerization reactors, that is, in a first polymerization reactor and two subsequent polymerization reactors, wherein the ethylene polymer prepared in the first polymerization reactor is an ethylene homopolymer, the ethylene polymer prepared in a first subsequent polymerization reactors is a first ethylene copolymer, and the ethylene polymer prepared in the second subsequent polymerization reactor is a second ethylene copolymer of a higher molecular weight. In some embodiments, the ethylene homopolymer is a low molecular weight ethylene homopolymer. In some embodiments, the first ethylene copolymer is a high molecular weight copolymer. In some embodiments, the second ethylene copolymer of a higher molecular weight is an ultrahigh molecular weight copolymer. In some embodiments, the resulting multimodal ethylene copolymers is made from or containing from 30 to 60% by weight, alternatively from 45 to 55% by weight, of ethylene homopolymer prepared in the first polymerization reactor, from 30 to 65% by weight, alternatively from 20 to 40% by weight, of ethylene copolymer prepared in the first subsequent polymerization reactor, and from 1 to 30% by weight, alternatively from 15 to 30% by weight, of higher molecular weight ethylene copolymer prepared in the second subsequent polymerization reactor.

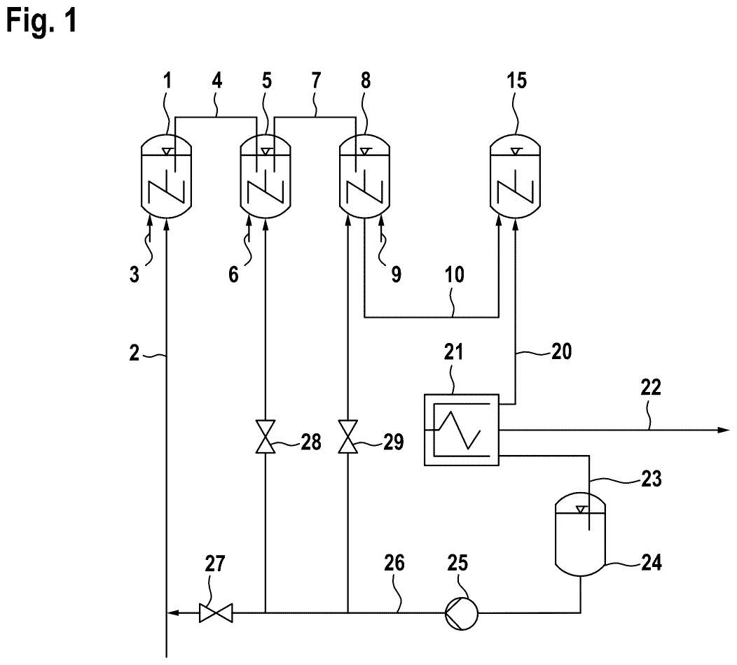

FIG. 1 shows a schematic of a slurry polymerization process for preparing multimodal ethylene polymers in a series of three polymerization reactors.

The diluent for polymerizing ethylene or copolymerizing ethylene and one or more C₃-C₁₂-1-alkenes in slurry in the first polymerization reactor (1) is fed to the reactor via feeding line (2) while the other components of the reaction mixture like catalyst, ethylene, possible comonomers, and polymerization auxiliaries are fed to the reactor via one or more feeding lines (3). As result of the polymerization in reactor (1), a slurry of solid polyolefin particle in a liquid medium is formed. This slurry is fed via line (4) to the second polymerization reactor (5) where further polymerization occurs. In some instances, fresh comonomer or further components of the reaction mixture are fed to reactor (5) via one or more feeding lines (6). The slurry of reactor (5) is thereafter fed via line (7) to the third polymerization reactor (8), in which additional polymerization is carried out. In some instances, one or more feeding lines (9) allow supplementary feeding of comonomer or further components of the reaction mixture to reactor (8).

The slurry of solid polyolefin particle in the liquid medium formed in reactor (8) is continuously transferred via line (10) to collecting vessel (15). The slurry is then passed via line (20) to centrifuge (21), where the solid polyolefin particles are separated from the liquid medium. In some instances and after removal of the liquid medium, the isolated polyolefin particles, having from 10 to 30 wt.-% of residual moisture, that is, of residual liquid medium, are transferred via line (22) to a dryer (not shown) and thereafter to a pelletizing unit (not shown).

The isolated liquid medium is transferred via line (23) to a further collecting vessel (24) and from there by pump (25) via line (26) to the polymerization reactors (1), (5), or (8). For controlling and regulating the transfer of the liquid medium to reactors (1), (5), or (8), line (26) and the line's branch-offs are equipped with valves (27), (28), and (29).

In some embodiments, the process is carried out in a reactor system including a polymerization reactor configured to have a content in liquid form or a solution of a polymer in a solvent. In some embodiments, the polymerization reactor is configured to have a content of a slurry of polymer particle in a liquid medium. In some embodiments, the reactor system further includes an agitator for agitating the reactor content. In some embodiments, the reactors of such reactors systems are stirred tank reactors.

In some embodiments, the polymerization reactors are cylindrical polymerization reactors having a cylindrical reactor wall, a bottom reactor head connected to the cylindrical reactor wall at a bottom tangent, and a top reactor head connected to the cylindrical reactor wall at a top tangent. In some embodiments, the cylindrical polymerization reactors have an inner diameter D, which corresponds to the inner diameter of the cylindrical reactor wall, and a height H, which is the distance from the bottom tangent to the top tangent measured along the central axis of the cylindrical polymerization reactor. In some embodiments, the cylindrical polymerization reactors have a height/diameter ratio (H/D) from 1.5 to 4, alternatively from 2.5 to 3.5. In some embodiments, the polymerization reactors have an internal surface in contact with the slurry that has a surface roughness Ra of less than 5 μm, alternatively less than 3 μm, alternatively less than 1.5 μm, determined according to ASME B46.1.

In some embodiments, the agitator of the reactor system induces a flow of the reactor content and allows the reactor content to mix. In some embodiments, the agitator is arranged centrally in the reactor. In some embodiments, the agitator has a motor located on the top reactor head, a rotating shaft extending along the reactor's central axis, and one or more stages of agitator blades. In some embodiments, there are 2 to 6 stages of agitator blades attached to the rotating shaft. In some embodiments, there are 4 or 5 stages of agitator blades. In some embodiments, a stage of agitator blades includes several agitator blades. In some embodiments, stages of agitator blades have from 2 to 4 blades.

In some embodiments, the motor rotates the agitator shaft and the attached agitator blades. In some embodiments, the rotation of the blades induces a vertical flow of the reactor content in a circular cross-section around the agitator shaft. In some embodiments, this vertical flow of the reactor content is a downward flow. At the bottom head, this flow changes direction, flowing first outward toward the reactor wall then back upward to the top. The flow changes direction again and then back to the center of the polymerization reactor. The rotation of the agitator also results in a secondary flow pattern of the reactor content in the reactor. This secondary flow is a circular flow in the direction of rotation of the agitator. In some embodiments and to control this circular flow; the polymerization reactor is equipped with one or more baffles.

The reactor system of the process supports the slurry polymerization of ethylene and optionally one or more comonomers. In some embodiments, the reactor system includes a polymerization reactor and one or more first heat exchangers, located outside the polymerization reactor.

In some embodiments, the reactor system includes one or more first heat exchangers, located outside the polymerization reactor for cooling or heating the reactor content. During polymerization, the heat of polymerization is removed from the polymerization reactor by withdrawing slurry from the polymerization reactor, cooling the slurry in the one or more first heat exchangers, and returning the cooled slurry to the polymerization reactor. In some embodiments, the one or more first heat exchangers are selected from the group consisting of double pipe heat exchangers, shell and tube heat exchangers, plate heat exchangers, plate and shell heat exchangers, and spiral heat exchangers.

In some embodiments, the first heat exchangers are double pipe heat exchangers. In some embodiments, the double pipe heat exchangers are long, jacketed pipes, which are from about 100 m to 600 m long. In some embodiments, the inner diameter of the pipes is in the range of from about 150 mm to 400 mm. In some embodiments, the double pipe heat exchangers are composed of individual jacketed segments. In some embodiments, the segments are flanged together, either directly or separated by a bend. In some embodiments, the bends are 180)° bend bends. In some embodiments, the straight individual segments have a length of from 6 m to 12 m. In some embodiments, each double pipe heat exchanger is composed of from 4 to 50, alternatively from 5 to 40, alternatively from 10 to 35, individual jacketed segments. In some embodiments, the flows of the reactor content and the flows of the tempering medium through the jackets of the double pipe heat exchangers are co-current, counter-current, or a combination of co-current/counter-current. In some embodiments, the flows in the first heat exchangers are a combination of co-current/counter-current.

In some embodiments, the first heat exchangers are double pipe heat exchangers, having an internal surface in contact with the slurry that has a surface roughness Ra of less than 5 um, alternatively less than 3 μm, alternatively less than 1.5 μm, determined according to ASME B46.1. In some embodiments, the surface roughness Ra is achieved by polishing, alternatively mechanical polishing or electropolishing.

In some embodiments, the reactor system has one first heat exchanger located outside the polymerization reactor. In some embodiments, the reactor system has two, three, four or more first heat exchangers located outside the polymerization reactor. In some embodiments, the reactor system has two or three first heat exchangers.

In some embodiments, the reactor system has one or more circulation pumps for withdrawing the reactor content from the polymerization reactor and circulating the reactor content through the one or more first heat exchangers. In some embodiments, the tempering medium is circulated by circulation pumps, providing a constant flow rate of the tempering medium at the outlets of the circulation pumps. In some embodiments, the one or more circulation pumps are arranged upstream of the one or more first heat exchangers, that is, between the outlet of the polymerization reactor where the withdrawn reactor content leaves the polymerization reactor and the one or more first heat exchangers. In some embodiments, the circulation pumps are centrifugal pumps, having a semi-open impeller made from electro-polished stainless steel.

In some embodiments, the tempering medium for cooling or heating the one or more first heat exchangers is circulated in a closed loop. In some embodiments, the reactor system has more than one first heat exchangers. In some embodiments, the first heat exchangers of the reactor system are operated in parallel in one closed loop of the circulating tempering medium. In some embodiments, the one or more first heat exchangers located outside the polymerization reactor serve for cooling and heating the content of the polymerization reactor. In some embodiments and depending on the function, the first heat exchangers are provided with (a) a cooling medium when cooling the content of the polymerization reactor or (b) a heating medium when heating the content of the polymerization reactor. In some embodiments, both tasks are performed by a tempering medium which serves for cooling the one or more first heat exchangers and which serves for heating the one or more first heat exchangers. In some embodiments, the closed loop of the tempering medium is equipped with two further heat exchangers, including a second heat exchanger for cooling the tempering medium and a third heat exchangers for heating the tempering medium.

In some embodiments, using the tempering medium as coolant takes place during the polymerization of ethylene or the copolymerization of ethylene and one or more C₃-C₁₂-1-alkenes in the polymerization reactor, thereby removing the heat of polymerization. In some embodiments, the second heat exchanger for cooling the tempering medium is cooled by a coolant. In some embodiments, the coolant is water. The coolant is provided through a coolant feed line, passed through the second heat exchanger, and then withdrawn through a coolant exit line. In some embodiments, the second heat exchanger for cooling the tempering medium is a plate heat exchanger. In some embodiments, the second heat exchanger is divided into a multitude of plate heat exchangers, operating in parallel. In some embodiments, the multitude of plate heat exchangers is a battery of two, three, four, five, six, seven, eight, nine, or ten plate heat exchangers, operating in parallel. In some embodiments, the second heat exchanger for cooling the tempering medium is a cooling tower, alternatively an atmospheric cooling tower.

In some embodiments and during polymerization, the temperature of the circulated tempering medium is maintained by adjusting the flow rate of the coolant through the second heat exchanger by a control valve, located in the coolant feed line, alternatively in the coolant exit line. In some embodiments, the temperature of the circulated tempering medium is controlled by splitting the stream of the tempering medium conveyed to the second heat exchanger into two portions. A first portion passes the second heat exchanger for being cooled by the coolant while the second portion bypasses the second heat exchanger and directly returns to the inlet side of the circulation pump circulating the tempering medium. In some embodiments, the flow rate of the tempering medium through the bypass is adjusted by a control valve located in the bypass line. Varying the opening of the control valve varies the ratio of the first portion of the tempering medium running through the second heat exchanger to the second portion bypassing the second heat exchanger and accordingly varies the temperature of the combined tempering medium after reuniting the first and second portions.

In some embodiments, using the tempering medium as a heating medium for the content of the polymerization reactor takes place in the start-up of the polymerization or during cleaning of the reactor system. In some embodiments, the third heat exchanger for heating the tempering medium is heated by a heating medium. In some embodiments, the heating medium is steam. In some embodiments, the heating medium is provided through a heating medium feed line, passed through the third heat exchanger, and then withdrawn through a heating medium exit line. In some embodiments, the third heat exchanger for heating the tempering medium is a shell and tube heat exchanger.

In some embodiments, the process is carried out as a multi-reactor polymerization in a combination of two, three or more reactor systems, the first heat exchangers are cooled or heated by a tempering medium which is circulated in one closed loop system, and the first heat exchangers are operated in parallel in the closed loop of the circulating tempering medium which is cooled by one second heat exchanger.

In some embodiments, the slurry in the polymerization reactor is cooled or heated in one or more first heat exchangers located outside the polymerization reactor and by a tempering jacket at the outside of the polymerization reactor. In some embodiments, the tempering jacket is tempered by the tempering medium cooling or heating the one or more first heat exchangers used for cooling or heating the reactor content. In some embodiments, the tempering jacket consists of a series of half-pipes attached to the outside of the polymerization reactor. In some embodiments, the first heat exchangers and the tempering jacket at the outside of the polymerization reactor are operated in parallel in the closed loop of the circulating tempering medium. In some embodiments, the process is carried out as a multi-reactor polymerization in a combination of two, three or more reactor systems and the reactors are equipped at the outside with a tempering jacket. In some embodiments, the first heat exchangers and the cooling jackets are operated in parallel in the closed loop of the circulating tempering medium.

In some embodiments and during the polymerization or the copolymerization, the polymerization reactor is filled with a slurry of ethylene polymer particles in a liquid medium made from or containing a hydrocarbon diluent, and the polymerization process includes (i) withdrawing slurry from the polymerization reactor, (ii) cooling the slurry in the one or more first heat exchangers, and (iii) returning the cooled slurry to the polymerization reactor.

In some embodiments and during the polymerization or the copolymerization, the temperature of the tempering medium cooling the one or more first heat exchangers is in the range from 20° C. to 50° C., alternatively from 25° C. to 45° C., alternatively from 29° C. to 40° C., and the tempering medium is cooled in the second heat exchanger by a coolant having a temperature from −20° to 45° C., alternatively from 15° C. to 40° C., alternatively from 20° C. to 36° C.

In some embodiments, the process includes a cleaning step for cleaning (a) the polymerization reactor, (b) the one or more first heat exchangers, or (c) the polymerization reactor and the one or more first heat exchangers. In some embodiments, the cleaning step includes the sub-steps of terminating the polymerization; introducing a hydrocarbon solvent into reactor system, thereby forming a cleaning fill; heating the cleaning fill; circulating the cleaning fill within the reactor system with operating the agitator within the polymerization reactor; discharging the cleaning fill from the reactor system; and resuming the polymerization or copolymerization in the reactor system.

In some embodiments, the termination of the polymerization or the copolymerization occurs by terminating the feed streams to the reactor system or the combination of double pipe reactor systems. In some embodiments, the termination of the polymerization or the copolymerization occurs continuing with the operation of the circulation pumps or the circulation pumps. As used herein, the phrase “terminating the feed streams” refers to no longer feeding ethylene, comonomer, catalyst, hydrogen, and hydrocarbon diluent to the reactor system. Thereafter, the slurry of ethylene polymer particles in the liquid medium is discharged from the reactor system until the reactor system is empty. In some embodiments, a method for discharging the slurry of ethylene polymer particles in a liquid medium from the multi-reactor slurry polymerization system is as described in Patent Cooperation Treaty Publication No. WO 2018/127472 A1.

In some embodiments and after emptying the reactor system from the slurry, the reactor system is flushed with a hydrocarbon, thereby removing ethylene polymer particles which remained in the reactor system after the slurry was discharged. In some embodiments, the hydrocarbon for flushing the reactor system is the hydrocarbon used as diluent in the polymerization. In some embodiments, the hydrocarbon for removing remaining ethylene polymer particles is introduced into the reactor system and then circulated by the one or more circulation pumps through the one or more first heat exchangers, for example, for from 10 min to 3 hours. In some embodiments and thereafter, the agitator of the polymerization reactor is stopped, and the circulation pumps are operated for from 1 hour to 12 hours, alternatively for from 1.5 hours to 8 hours, alternatively for from 2 hours to 4 hours. In some embodiments and subsequently, the circulation pumps are stopped, and the content of the reactor is discharged. In some embodiments, the content of the reactor is discharged through a bottom outlet of the polymerization reactor. In some embodiments, the agitator of the polymerization reactor is restarted while a part of the hydrocarbon, used for flushing the reactor system, is left in the polymerization reactor. In some embodiments, at least the bottom part of the polymerization reactor is flushed a second time with hydrocarbon, thereby removing remaining ethylene polymer particles.

For cleaning the reactor system, a hydrocarbon solvent is introduced into the emptied reactor system, thereby forming a cleaning fill within the reactor system. In some embodiments, the hydrocarbon solvent for cleaning the reactor system is the hydrocarbon diluent used in the polymerization. In some embodiments, the hydrocarbon solvent is introduced into the emptied reactor system until a liquid level of the cleaning fill within the polymerization reactor is reached which is at least as high as the liquid level of the slurry within the polymerization reactor during polymerization. In some embodiments, the reactor system is completely filled with the hydrocarbon solvent.

In some embodiments and thereafter, the cleaning fill within the reactor system is heated to a temperatures from 100° C. to 180° C., alternatively from 110° C. to 170° C., alternatively from 120° C. to 160° C., while the agitator within the polymerization reactor is operated. In some embodiments, the heating occurs by withdrawing parts of the cleaning fill from the polymerization reactor, heating the withdrawn parts of the cleaning fill in the one or more first heat exchangers, and returning the heated parts of the cleaning fill to the polymerization reactor. In some embodiments, the tempering medium is heated in the third heat exchanger by providing the third heat exchanger with a heating medium having a temperature from 150° C. to 250° C., alternatively from 170° C. to 230° C., alternatively from 180° C. to 210° C. In some embodiments, the heating medium for heating the third heat exchanger is steam, having a pressure from 0.6 MPa to 1.5 MPa, alternatively from 0.7 MPa to 1.1 MPa. In embodiments, the cleaning fill is heated by passing parts of the cleaning fill through the heated one or more first heat exchangers and by heating the tempering jacket at the outside of the polymerization reactor.

In some embodiments, the heated cleaning fill is maintained within the reactor system at the temperature from 100° C. to 180° C., alternatively from 110° C. to 170° C., alternatively from 120° C. to 160° C., for from 4 hours to 120 hours, alternatively from 10 hours to 80 hours, alternatively from 15 hours to 50 hours, with continued circulation of the cleaning fill through the one or more first heat exchangers and continued operation of the agitator.

In some embodiments, the cleaning fill is subsequently discharged from the reactor system until the reactor system is empty. Thereafter, the polymerization of ethylene or the copolymerization of ethylene and one or more C₃-C₁₂-1 alkenes is resumed in the reactor system.

In some embodiments, the contents of the polymerization reactor and of the one or more first heat exchangers are discharged together through one outlet of the reactor system. In some embodiments, the content of the polymerization reactor and the contents of the one or more first heat exchangers are discharged separately through two or more outlets of the reactor system. In some embodiments, the circulation of the cleaning fill from the polymerization reactor through the one or more first heat exchangers is terminated and the contents of the one or more first heat exchangers and of the polymerization reactor are subsequently discharged through two or more outlets of the reactor system.

In some embodiments, the introduction of the hydrocarbon solvent into the reactor system is terminated after a cleaning fill within the reactor system has been formed, and thereafter, the cleaning fill within the reactor system is maintained at a temperature from 100° C. to 180° C. and the discharge of the cleaning fill from the reactor system occurs without introduction of additional hydrocarbon solvent.

In some embodiments, the introduction of the hydrocarbon solvent into the reactor system is not terminated after a cleaning fill within the reactor system has been formed, and the liquid level of the cleaning fill within the polymerization reactor is maintained by discharging cleaning fill from the reactor system. It is believed that continuously introducing hydrocarbon solvent and continuously withdrawing cleaning fill from the reactor system provides that a viscosity increases of the cleaning fill within the reactor system by the dissolution of the oligomeric or polymeric walls layers is less pronounced and that a saturation of the cleaning fill with dissolved walls layers does not take place or at least is reached later.

In some embodiments, the cleaning fill which is discharged from the reactor system is transferred into an agitated evaporation vessel which is configured to allow withdrawal of hydrocarbon solvent by evaporation from a liquid medium made from or containing the hydrocarbon solvent. In some embodiments, the discharge of the cleaning fill from the reactor system into the agitated distillation vessel occurs by a pressure difference between the cleaning fill within the reactor system and the agitated distillation vessel. In some embodiments, the depressurization of the hot cleaning fill occurs while entering the evaporation vessel, thereby resulting in a temperature drop combined with an evaporation of an amount of hydrocarbon solvent.

In some embodiments, the evaporation vessel is first filled with cleaning fill discharged from the reactor system and thereafter the evaporation of the hydrocarbon solvent is started. In some embodiments, the evaporation is continued until a concentrated mixture of the dissolved oligomeric and polymeric materials and remaining hydrocarbon solvent is formed. In some embodiments, at least a part of the dissolved oligomeric and polymeric materials is precipitated. In some embodiments and after discharging the remaining concentrated mixture, the evaporation vessel is filled again with cleaning fill discharged from the reactor system. In some embodiments and because the agitated evaporation vessel is completely filled, cleaning fill discharged from the reactor system is fed into a second agitated evaporation vessel instead of interrupting the discharge until the agitated evaporation vessel is emptied again.

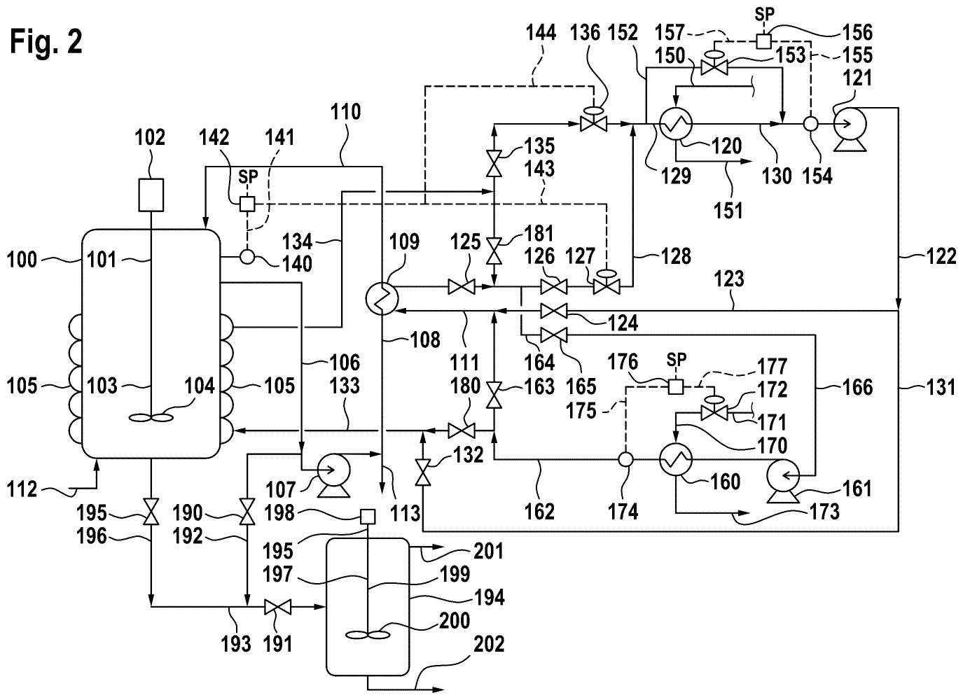

FIG. 2 shows a schematic of a reactor system of a slurry process for polymerizing ethylene or copolymerizing ethylene and one or more C₃-C₁₂-1-alkenes.

Polymerization reactor (100) includes an agitator (101) for agitating the contents of the reactor. The agitator (101) has a motor (102), a rotating shaft (103) which is vertically installed centrally into reactor (100), and at least one impeller (104). The polymerization reactor (100) is equipped with a tempering jacket (105) on the outside surface of the reactor (100) through which a tempering medium flows. Reactor content is withdrawn from polymerization reactor (100) through line (106) to circulation pump (107), which then pumps the reactor content through line (108) to the first heat exchanger (109). The tempered reactor content which has passed the first heat exchanger (109) flows back to polymerization reactor (100) through line (110). The tempering medium for tempering the first heat exchanger (109) comes through line (111).

The components of the reaction mixture, such as catalyst components, ethylene, possible comonomers, hydrogen and the hydrocarbon diluent, are fed to the reactor via one or more feeding lines (112). During the polymerization of ethylene or the copolymerization of ethylene and one or more C₃-C₁₂-1-alkenes in polymerization reactor (100), slurry is withdrawn from polymerization reactor (100), and the first heat exchanger (109) operates as cooler. Slurry is further routed to a downstream reactor or to product recovery through line (113).

While polymerizing, valves (163), (165), (180) and (181) are closed. The cooled tempering medium for cooling the first heat exchanger (109) comes from the second heat exchanger (120). The cooled tempering medium, leaving the second heat exchanger (120) through line (130), is circulated by a second circulation pump (121) through lines (122) and (123), valve (124), and line (111) to the first heat exchanger (109), and then through valves (125) and (126), control valve (127), and lines (128) and (129), back to the second heat exchanger (120)).

In some instances and while polymerizing, the tempering jacket (105) of the polymerization reactor (100) is cooled by the tempering medium. For cooling the tempering jacket (105), the second circulation pump (121) circulates the cooled tempering medium leaving the second heat exchanger (120) through line (130), through lines (122) and (131), valve (132), and line (133) to the tempering jacket (105), and then through line (134), valve (135), control valve (136), and line (129), back to the second heat exchanger (120).

To control the temperature of polymerization reactor (100), temperature transducer (140) produces a temperature signal (141) which is representative of the temperature of polymerization reactor (100). Temperature controller (142) receives the temperature signal (141) along with a setpoint (SP) which is representative of the temperature goal for the polymerization reactor (100). In response to temperature signal (141), temperature controller (142) provides output signals (143) and (144), which are responsive to the difference between temperature signal (141) and the setpoint for the reactor temperature. Control valves (127) and (136) which are controlling the flows of the tempering medium from the first heat exchanger (109) and the tempering jacket (105) to the second heat exchanger (120) are manipulated in response to signals (143) and (144).

The tempering medium is cooled in the second heat exchanger (120) using a coolant entering the second heat exchanger (120) through line (150) and leaving the second heat exchanger (120) through line (151). To control the temperature of the tempering medium cooling the first heat exchanger (109), part of the tempering medium conveyed through line (129) bypasses the second heat exchanger (120) through line (152). The flow of the tempering medium bypassing the second heat exchanger (120) is adjusted by control valve (153). Temperature transducer (154) produces a temperature signal (155), which is representative of the temperature of the combined tempering medium after merging the part of the tempering medium passing the second heat exchanger (120) and the part of the tempering medium bypassing the second heat exchanger (120) through line (152). Temperature controller (156) receives the temperature signal (155) along with a setpoint (SP) which is representative of the temperature goal for the tempering medium entering the second circulation pump (121). In response to temperature signal (155), temperature controller (156) provides output signal (157), which is responsive to the difference between temperature signal (155) and the setpoint for the temperature of the tempering medium flowing in line (130). Control valve (153) is manipulated in response to signal (157).

For cleaning (a) the polymerization reactor, (b) the one or more first heat exchangers, or (c) the polymerization reactor and the one or more first heat exchangers, the first heat exchanger (109) is operated as heater for heating the parts of the reactor content, which are withdrawn from the polymerization reactor (100) and circulated through the first heat exchanger (109).

For heating the content of the polymerization reactor (100), valves (124), (126), (132), and (135) are closed and the tempering medium for heating the first heat exchanger (109) comes from the third heat exchanger (160). The tempering medium is circulated by a third circulation pump (161) through the third heat exchanger (160), line (162), valve (163), and line (111) to the first heat exchanger (109), and then through valve (125), line (164), valve (165), and line (166), back to the third circulation pump (161).

The tempering medium is heated in the third heat exchanger (160). In some instances, the tempering medium is heated using medium pressure steam entering the third heat exchanger (160) through line (170). The medium pressure steam comes through line (171) to control valve (172), which adjusts the flow of the medium pressure steam. The medium pressure steam then flows through line (170) into the third heat exchanger (160), through the third heat exchanger (160), and then exits the third heat exchanger (160) through line (173). To control the temperature of the tempering medium heating the first heat exchanger (109), temperature transducer (174) produces a temperature signal (175), which is representative of the temperature of the tempering medium leaving the third heat exchanger (160) through line (162). Temperature controller (176) receives the temperature signal (175) along with a setpoint (SP) which is representative of the temperature goal for the tempering medium flowing in line (162). In response to temperature signal (175), temperature controller (176) provides output signal (177), which is responsive to the difference between temperature signal (175) and the setpoint for the temperature of the tempering medium flowing in line (162). Control valve (172) is manipulated in response to signal (177).

In some instances, the tempering jacket (105) is heated using the tempering medium. The tempering medium is then circulated by the third circulation pump (161) through the third heat exchanger (160), line (162), valve (180), and line (133) to the tempering jacket (105), and then through line (133), valve (181), line (164), valve (165) and line (166), back to the third circulation pump (161).

After cleaning the reactor system, operation of the circulation pumps (107) and (161) is stopped, the valves (190) and (191) are opened, and the content of the first heat exchanger (109) is discharged through line (108), circulation pump (107), valve (190), lines (192) and (193), and valve (191) into evaporation vessel (194). Once the first heat exchanger (109) is empty, valve (190) is closed, valve (195) is opened, and the content of the polymerization reactor (100) is discharged through valve (195), lines (196) and (193), and valve (191) into evaporation vessel (194).

The evaporation vessel (194) includes an agitator (197) for agitating the contents of the reactor. The agitator (197) has a motor (198), a rotating shaft (199) which is vertically installed centrally into the evaporation vessel (194), and at least one impeller (200). During evaporation, evaporated hydrocarbon solvent is withdrawn through line (201) to the off-gas system (not shown). After the evaporation, a concentrated mixture of dissolved oligomeric and polymeric materials and remaining hydrocarbon solvent is withdrawn through line (202) and discarded.

### EXAMPLES

### Comparative Example A

Ethylene polymers were continuously prepared in a commercially operated series of three reactor systems having each a polymerization reactor as shown in FIG. 1. Each polymerization reactor was part of a reactor system further including two parallel first heat exchangers, located outside the polymerization reactor for removing the heat of polymerization. The first heat exchangers included straight jacketed segments, having each a length of 12 m, which segments were flanged together. The polymerization reactors were further equipped with tempering jackets. The first heat exchangers and the tempering jackets of the polymerization reactors were cooled by a coolant, which circulated in a closed loop, and the coolant was cooled in a second heat exchanger. For a period of more than five years, polymerizations of ethylene and 1-butene as comonomer were carried out in slurry in the presence of Ziegler-type catalysts at reactor temperatures in the range from 65° C. to 85° C. and reactor pressures from 0.2 MPa to 1.3 MPa, thereby preparing a variety of different polyethylene grades. Depending on the grades, the production rate varied in the range from 30 to 41 t/h.

During this period of time, a decrease of the heat transfer in the heat exchanger was regularly observed, which was believed to be caused by build-up of wax layers within the first heat exchangers. To remove the wax layers within the first heat exchangers, the reactor system was cleaned with hot hydrocarbons on average, twice a year. For heating the reactor contents during the cleaning, the first heat exchangers and the tempering jackets were separated from the closed loop of circulating coolant and connected with a supply of saturated steam having a pressure of 0.8 MPa. Each cleaning of the first heat exchangers and the tempering jackets of the polymerization reactors took 5 days from the termination of the polymerization to the resumption of the polymerization after the reactor system had been cleaned.

At the end of the five years period, an inspection of the first heat exchangers took place and about 20% of the straight segments of the first heat exchangers were heavily corroded. Accordingly, the corroded segments were replaced because there was a risk of coolant leakage during future uses.

### Example 1

Ethylene polymers were continuously prepared in a commercially operated series of three reactor systems having each a polymerization reactor as shown in FIG. 1. Each polymerization reactor was part of a reactor system as shown in FIG. 2, however having two parallel first heat exchangers located outside the polymerization reactor instead of one as shown in FIG. 2 for removing the heat of polymerization. The first heat exchangers included straight jacketed segments, having each a length of 12 m, which segments were flanged together. The polymerization reactors were further equipped with tempering jackets. The first heat exchangers and the tempering jackets of the polymerization reactors were cooled by a tempering medium, which circulated in a closed loop. During polymerization, the tempering medium was cooled in a second heat exchanger. For a period of more than five years, polymerizations of ethylene and 1-butene as comonomer were carried out in slurry in the presence of Ziegler-type catalysts at reactor temperatures in the range from 65° C. to 85° C. and reactor pressures from 0.2 MPa to 1.3 MPa, thereby preparing a variety of different polyethylene grades. Depending on the grades, the production rate varied in the range from 30 to 41 t/h.

During this period of time, a decrease of the heat transfer in the heat exchanger was regularly observed, which was believed to be caused by a build-up of wax layers within the first heat exchangers. To remove the wax layers within the first heat exchangers, the reactor system was cleaned with hot hydrocarbons on average, twice a year. For heating the reactor contents, the closed loop of circulating tempering medium was equipped with a third heat exchanger that was connected with a supply of saturated steam having a pressure of 0.9 MPa. Each cleaning of the first heat exchangers and the tempering jackets of the polymerization reactors took 3 days from the termination of the polymerization to the resumption of the polymerization after the reactor system had been cleaned.

At the end of the five years period, an inspection of the first heat exchangers took place. None of the straight segments of the first heat exchangers was heavily corroded. Accordingly, the segments were not replaced.

1. A process for polymerizing ethylene or copolymerizing ethylene and one or more C₃-C₁₂-1-alkenes in a slurry polymerization at temperatures of from 40 to 150° C. and pressures from 0.1 to 5 MPa in the presence of a polymerization catalyst,
wherein the process is carried out in a reactor system comprising
a polymerization reactor configured to have a content in liquid form;
an agitator for agitating the reactor content;
one or more first heat exchangers located outside the polymerization reactor for cooling or heating the reactor content;
one or more circulation pumps for withdrawing the reactor content from the polymerization reactor and circulating the reactor content through the one or more first heat exchangers; and
a closed loop of a tempering medium for cooling or heating the one or more first heat exchangers, wherein the closed loop is equipped with a second heat exchangers for cooling the tempering medium and a third heat exchangers for heating the tempering medium, and
the process comprises the steps of:
filling the polymerization reactor with a slurry of ethylene polymer particles in a liquid medium comprising a hydrocarbon diluent;
withdrawing slurry from the polymerization reactor;
cooling the slurry in the one or more first heat exchangers;
returning the cooled slurry to the polymerization reactor;
cooling the one or more first heat exchangers with the tempering medium having a temperature in the range of from 20° C. to 50° C.; and
cooling the tempering medium in the second heat exchanger by a coolant having a temperature from −20° to 45° C.

2. The process of claim 1, wherein the reactor system is a part of a series of two, three, or more reactor systems comprising each a polymerization reactor and one or more first heat exchangers located outside the polymerization reactor for cooling or heating the reactor content.

3. The process of claim 1, wherein the first heat exchangers are double pipe heat exchangers.

4. The process of claim 1, wherein the polymerization reactors are further equipped at the reactor outside with tempering jackets.

5. The process of claim 4, wherein the tempering jackets consist of a series of half-pipes attached to the outside of the polymerization reactors.

6. The process of claim 4, wherein the tempering medium for cooling or heating the tempering jacket is the tempering medium for cooling or heating the one or more first heat exchangers.

7. The process of any of claim 1 further comprising a cleaning step for cleaning (a) the polymerization reactor, (b) the one or more first heat exchangers, or (c) the polymerization reactor and the one or more first heat exchangers, wherein the cleaning step comprises the sub-steps of
terminating the polymerization of ethylene or the copolymerization of ethylene and one or more C₃-C₁₂-1-alkenes in the reactor system and discharging the slurry of ethylene polymer particles from the reactor system until the reactor system is empty,;
introducing a hydrocarbon solvent into the emptied reactor system, thereby forming a cleaning fill within the reactor system;
heating the cleaning fill within the reactor system to a temperatures from 100 to 180° C., including further sub-steps of
(i) operating the agitator within the polymerization reactor;
(ii) heating the cleaning fill by withdrawing parts of the cleaning fill from the polymerization reactor, heating the parts of the cleaning fill in the one or more first heat exchangers, and returning the heated parts of the cleaning fill to the polymerization reactor; and
(iii) heating the tempering medium in the third heat exchanger by providing the third heat exchanger with a heating medium having a temperature from 150° C. to 250° C.;
maintaining the cleaning fill within the reactor system at the temperature from 100° C. to 180° C. for from 4 to 120 hours with continued circulation of the cleaning fill through the one or more first heat exchangers and continued operation of the agitator;
discharging the cleaning fill from the reactor system until the reactor system is empty; and
resuming polymerizing ethylene or copolymerizing ethylene and one or more C₃-C₁₂-1 alkenes in the reactor system.

8. The process of claim 7, wherein, after discharging the slurry of ethylene polymer particles from the reactor system and before introducing the cleaning fill into the reactor system, the process further comprises a sub-step of flushing the reactor system with hydrocarbon diluent.

9. The process of claim 7, wherein the hydrocarbon solvent is introduced into the emptied reactor system until a liquid level of the cleaning fill within the polymerization reactor is at least as high as the liquid level of the slurry within the polymerization reactor during polymerization.

10. The process of claim 7, wherein the introduction of the hydrocarbon solvent into the reactor system is terminated after a cleaning fill within the reactor system has been formed, thereafter the cleaning fill within the reactor system is maintained at the temperature from 100° C. to 180° C., the discharge of the cleaning fill from the reactor system occurs without introducing additional hydrocarbon solvent.

11. The process of claim 7, wherein, during the maintenance of the cleaning fill within the reactor system at a temperature from 100° C. to 180° C., hydrocarbon solvent is continuously introduced into the reactor system and cleaning fill is continuously discharged from the reactor system.

12. The process of claim 7, wherein, for emptying the reactor system before resuming the polymerization, the circulation of the cleaning fill from the polymerization reactor through the one or more first heat exchangers is terminated and the contents of the one or more first heat exchangers and the polymerization reactor are subsequently discharged.

13. The process of claim 7, wherein the cleaning fill, discharged from the reactor system, is transferred into an agitated evaporation vessel, which is configured to allow withdrawal of hydrocarbon solvent by evaporation from a liquid medium comprising the hydrocarbon solvent.

14. The process of claim 13, wherein the discharge of the cleaning fill from the reactor system into the agitated distillation vessel occurs by a pressure difference between the cleaning fill within the reactor system and the agitated distillation vessel.

15. The process of claim 2, wherein the resulting ethylene polymers are bimodal or multimodal ethylene polymers.
